(19) United States
(12) Patent Application Publication
(10) Pub. No.: US 2024/0290025 A1
(43) Pub. Date: Aug. 29, 2024

(54) AVATAR BASED ON MONOCULAR IMAGES

(71) Applicant: GOOGLE LLC, Mountain View, CA (US)

(72) Inventors: Yinda Zhang, Palo Alto, CA (US); Sean Ryan Francesco Fanello, San Francisco, CA (US); Ziqian Bai, Burnaby (CA); Feitong Tan, Mountain View, CA (US); Zeng Huang, Los Angeles, CA (US); Kripasindhu Sarkar, Zurich (CH); Danhang Tang, West Hollywood, CA (US); Di Qiu, Kitchener (CA); Abhimitra Meka, San Francisco, CA (US); Ruofei Du, San Francisco, CA (US); Mingsong Dou, Cupertino, CA (US); Sergio Orts Escolano, Zurich (CH); Rohit Kumar Pandey, Sunnyvale, CA (US); Thabo Beeler, Egg (CH)

(21) Appl. No.: 18/588,948

(22) Filed: Feb. 27, 2024

Related U.S. Application Data
(60) Provisional application No. 63/487,214, filed on Feb. 27, 2023.

(51) Int. Cl. G06T 13/40; G06T 7/90; G06T 17/20; G06V 10/44

(52) U.S. Cl. CPC G06T 13/40; G06T 7/90; G06T 17/20; G06V 10/44; G06T 2207/10024; G06T 2207/20084

(57) ABSTRACT

A method comprises receiving a first sequence of images of a portion of a user, the first sequence of images being monocular images; generating an avatar based on the first sequence of images, the avatar being based on a model including a feature vector associated with a vertex; receiving a second sequence of images of the portion of the user; and based on the second sequence of images, modifying the avatar with a displacement of the vertex to represent a gesture of the avatar.

### CROSS-REFERENCE TO RELATED APPLICATION

This application claims the benefit of priority to U.S. Provisional Application No. 63/487,214, filed on Feb. 27, 2023, the disclosure of which is hereby incorporated by reference.

### BACKGROUND

Users can communicate with each other by videoconference. They may wish to present avatars of themselves rather than actual images of themselves. When the user is talking, modifying the avatar to match expressions of the user can improve the realism of the videoconference.

### SUMMARY

This disclosure is related to generating an avatar and facial expressions using, for example, a single camera rather than using multiple cameras and/or a depth camera. The avatar can be generated by predicting expression-dependent features on a surface of a morphable model. Specifically, a computing system can be configured to generate an avatar based on a first video of a user, and later modify the avatar to present facial expressions based on a second video of the user. The first video can include monocular images, such as images captured by a color camera. The images can include a portion of a user, and the avatar can be based on a model such as a three-dimensional morphable model. The model can include multiple vertices, and the model can include feature vectors associated with the vertices.

The computing system can be configured to modify the avatar based on the second sequence of images. Specifically, the avatar can be modified to present facial expressions corresponding to facial expressions of the user in the second sequence of images. In some implementations, the avatar can be modified by displacing the vertices included in the model.

According to an example, a method comprises receiving a first sequence of images of a portion of a user, the first sequence of images being monocular images; generating an avatar based on the first sequence of images, the avatar being based on a model including a feature vector associated with a vertex; receiving a second sequence of images of the portion of the user; and based on the second sequence of images, modifying the avatar with a displacement of the vertex to represent a gesture of the avatar.

According to an example, a non-transitory computer-readable storage medium comprising instructions stored thereon. When executed by at least one processor, the instructions are configured to cause a computing system to receive a first sequence of images of a portion of a user, the first sequence of images being monocular images; generate an avatar based on the first sequence of images, the avatar being based on a model including a feature vector associated with a vertex; receive a second sequence of images of the portion of the user; and based on the second sequence of images, modify the avatar with a displacement of the vertex to represent a gesture of the avatar.

According to an example, a computing system comprises at least one processor and a non-transitory computer-readable storage medium. The non-transitory computer-readable storage medium comprises instructions stored thereon that, when executed by the at least one processor, are configured to cause the computing system to receive a first sequence of images of a portion of a user, the first sequence of images being monocular images; generate an avatar based on the first sequence of images, the avatar being based on a model including a feature vector associated with a vertex; receive a second sequence of images of the portion of the user; and based on the second sequence of images, modify the avatar with a displacement of the vertex to represent a gesture of the avatar.

The details of one or more implementations are set forth in the accompanying drawings and the description below. Other features will be apparent from the description and drawings, and from the claims.

### BRIEF DESCRIPTION OF THE DRAWINGS

FIG. 1 shows a first user and a second user engaging in a videoconference with a first avatar representing the first user and a second avatar representing the second user.

FIGS. 2A and 2B show avatars with expressions that are generated based on videos.

FIG. 3 shows a pipeline for generating an avatar with a facial expression.

FIG. 4 shows vertices included in a model of an avatar.

FIG. 5 shows a pipeline for generation of an image based on vertices and features included in the model of the avatar.

FIG. 6 shows a computing system for generation and modification of an avatar.

FIG. 7 shows a flowchart for generation and modification of an avatar.

Like reference numbers refer to like elements.

### DETAILED DESCRIPTION

Generating facial expression of avatars that represent users by capturing images of the users via cameras can be helpful in various types of communication systems such as videoconferencing systems. In low data-rate conditions, for example, sending full images of the users may not be feasible.

The avatars can be generated and presented during videoconferences. Rather than presenting an actual video stream with the face and/or head of the user, the computing system generates and/or presents an avatar of the user. The avatar can be modified to reflect facial expressions made by a user that are captured by a camera that is capturing images of the user.

At least one technical problem with generating avatars and facial expressions based on some cameras, such as depth cameras, is that depth cameras may be expensive and often can involve using at least two cameras. At least one technical solution is to generate a model of an avatar using vertices in a UV space based on a sequence of images captured by a monocular camera. As described herein, a computing system can be configured to generate an avatar, and facial expressions for the avatar, based on images of a user captured by a camera. In some examples, the camera is a monocular camera, including a single sensor. In some examples, the camera is a color camera such as a red-green-blue (RGB) camera. The generation of the avatar and facial expressions can be based on images captured by a monocular and/or color camera, which can enable the use of an inexpensive camera, such as a webcam. At least one technical problem with capturing images by a monocular and/or color camera is difficulty in generating a three-dimensional model based on the images captured by the monocular and/or color camera.

At least one technical solution to the technical problem of expense and size of depth cameras is to generate the avatar based on a sequence of images captured by a monocular camera. A technical solution to the technical problem of the difficulty of generating a three-dimensional model based on images captured by a monocular and/or color camera, is for a computing system to generate a model of the avatar that includes vertices in a UV space. The computing system generates features associated with the vertices. The computing system displaces the vertices to generate facial expressions corresponding to facial expressions of the user captured by the camera. Facial expressions can include configurations of the face that deviations from a neutral (relaxed) position that can indicate smiles, frowns, surprised looks, or quizzical looks, as non-limiting examples. At least one technical benefit of generating features associated with vertices and displacing the vertices to generate facial expressions is reduced expense and size of camera while generating a three-dimensional model.

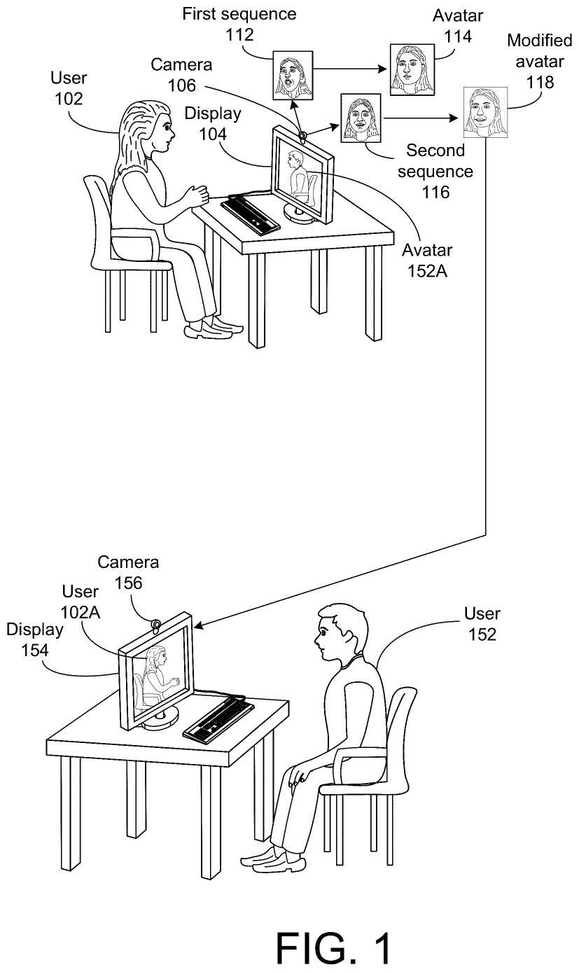

FIG. 1 shows a first user 102 and a second user 152 engaging in a videoconference with a first avatar 102A representing the first user 102 and a second avatar 152A representing the second user 152. A display 154 of a computing system interacting with the second user 152 presents the first avatar 102A to the second user 152. A display 104 of a computing system interacting with the first user 102 presents the second avatar 152A to the first user 102. The respective displays 154, 104 present avatars 102A, 152A that change and/or are modified in real time to correspond to changes of facial expressions of the users 102, 152. The first user 102 and second user 152 thereby view avatars representing each other during the videoconference. The avatars 102A, 152A can include gestures such as facial expressions corresponding to facial expressions formed by the respective users 102, 152 that are captured by the respective cameras 106, 156.

A computing system can generate the first avatar 102A representing the first user 102 based on images captured by a camera 106. The camera 106 can be included in and/or in communication with the computing system that generates the first avatar 102A. In some implementations, the camera 106 can include a monocular camera and/or color (such as red-green-blue or RGB) camera, such as a webcam. The camera 106 can include, for example, a digital single-lens reflex (DSLR) camera, a mirrorless camera, or a compact camera. In some implementations, the camera 106 can be included in and/or attached to the display 104 that the first user 102 is in front of. In some implementations, the camera 106 is displaced from (e.g., is separate from) the display 104, such as mounted to a desk, to a wall, or held by the user 102.

The camera 106 can capture a first sequence of images 112 of a portion the first user 102. The first sequence of images 112 can include and/or form a video of the user 102. The first sequence of images 112 can include monocular images captured by a monocular camera and/or color camera. In some examples, the images included in the first sequence of images 112 are considered frames. In an example in which the images are considered frames and the first sequence of images 112 includes M frames, the frames can be denoted {I₁, I₂, . . . , I_{M}}. The portion of the first user 102 captured by the camera 106 can include a head and/or face of the first user 102.

The computing system can generate a model of the face and/or head of the first user 102 based on the first sequence of images 112. The computing system can generate an avatar 114 based on the model of the face and/or head of the first user 102 that the computing system generated based on the first sequence of images 112. The first avatar 102A can be based on the avatar 114 and/or be based on the model of the face and/or head of the first user 102.

In some implementations, the model can include, for example, a three-dimensional morphable model (3DMM). The computing system is able to translate and/or transform the 3DMM into a two-dimensional representation for presentation on a computer display. The 3DMM is a three-dimensional model, such as a three-dimensional model of a head of a user, that the computing system can translate and/or transform into a two-dimensional representation for presentation on the computer display. A 3DMM can include a mesh representation of a three-dimensional object such as a face. The mesh representation can include shapes such as polygons with vertices. An example of a mesh representation is a triangle mesh with each triangle having three vertices. The triangles within the mesh can form a surface of the three-dimensional object. In some examples, vertices of the triangles can have locations within three-dimensional space, such as X, Y, and Z locations. In some examples, the vertices have locations in UV space. The UV space can be represented by axes U and V in a two-dimensional texture that forms the mesh representation. A vertex can be a point where two or more curves, lines, or edges of a shape in the mesh representation meet.

The model can include feature vectors attached to the vertices. The feature vectors are vectors containing multiple elements about the vertices, such as color and/or density. In some examples, density can indicate intensity (such as brightness) of the color. In some examples, density can indicate a number of pixels per unit of area. The feature vectors can include color values and density values associated with the vertices to which the feature vectors are attached.

After the computing system generates the avatar 114, the camera 106 can capture a second sequence of images 116 of the portion of the first user 102. The second sequence of images 116 can include and/or form a video of the user 102. The second sequence of images 116 can include monocular images captured by a monocular camera and/or color camera. The second sequence of images 116 may have been captured by the same camera that captured the first sequence of images 112. Based on the second sequence of images 116, the computing system can modify the avatar 114 to generate a modified avatar 118. The computing system can modify the avatar 114 to generate the modified avatar 118 by displacing one or more vertices in the model based on which the computing system generated the avatar 114. The modified avatar 118 can include one or more gestures, such as facial expressions, of the user 102.

In some examples, the second sequence of images 116 is captured by a camera that is different than the camera that captured the first sequence of images 112. A first camera can capture the first sequence of images 112, and the avatar 114 can be generated based on the first sequence of images 112. The avatar 114 can be stored in association with the first user 102. During a later session at a different computer and/or different (second) camera, the first user 102 can participate in a videoconference. The second camera can capture the second sequence of images 116. A computing system can modify the avatar 114 to generate the modified avatar 118 based on the second sequence of images 116 to present the first avatar 102A to a remote participant of the videoconference.

Displacing a vertex can include changing a location of the vertex. When the location of the vertex is identified in UV space by U and V values, displacing the vertex includes changing a U and/or V value of the vertex. When the location of the vertex is identified in three-dimensional space by X, Y, and Z values, displacing the vertex includes changing an X, Y, and/or Z value of the vertex. Displacing the vertex changes the shapes and locations of the shapes (such as triangles) that include the vertex.

The computing system can generate multiple instances of the modified avatar 118. The multiple instances can have different variations of gestures or facial expressions of the user 102. In other words, the multiple instances of the modified avatar 118 can be included in multiple images and/or frames that will be presented to the user 152. The multiple instances of the modified avatar 118 can be different from each other as the face of the user 102 gradually changes between facial expressions. The computing system can send the multiple instances of the modified avatar 118 to the second computing system for presentation on the display 154. The display 154 can present the multiple instances of the modified avatar 118 as an animation corresponding to facial expressions made by the user 102 during the videoconference.

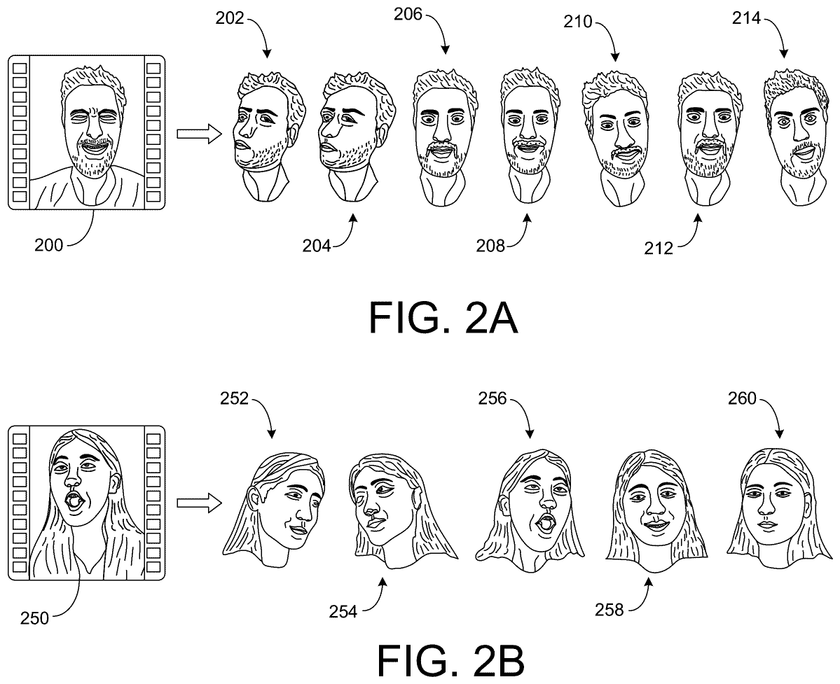

FIGS. 2A and 2B show avatars 202 to 214 and 252 to 260 with expressions that are generated based on videos 200, 250. The avatars 202 to 214 can be based on a first video 200. The avatars 252 to 260 can be based on a second video 250. The videos 200, 250 can include sequences of images. A computing system can generate the avatars 202 to 214 based on the video 200, and/or generate the avatars 252 to 260 based on the video 250, in a similar manner to the computing system described with respect to FIG. 1 generating the modified avatar 118 based on the second sequence of images 116.

The computing system can generate a three-dimensional avatar representation of a person (or portion of a person such as a head of the person), such as the first user 102 or second user 152, based on a short video such as the first video 200 or second video 250. The first video 200 and/or second video 250 can be a monocular video captured by a color camera, such as a monocular camera with a color (e.g. red-green-blue) camera. The computing system can apply a three-dimensional morphable model (3DMM) to capture and/or track expressions of a user within the video 200, 250. The computing system can anchor a neural radiance field to the 3DMM and generate a volumetric, photorealistic three-dimensional avatar, such as the avatar 114. The neural radiance field can be a connected neural network that can generate novel views of three-dimensional scenes (such as three-dimensional views of the avatar 114) based on a partial set of two-dimensional images (such as the first sequence of images 112 and/or second sequence of images 116). The computing system can modify the avatar with facial expressions based on facial expressions of the user 102, 152 included in images captured by the camera 106, 156.

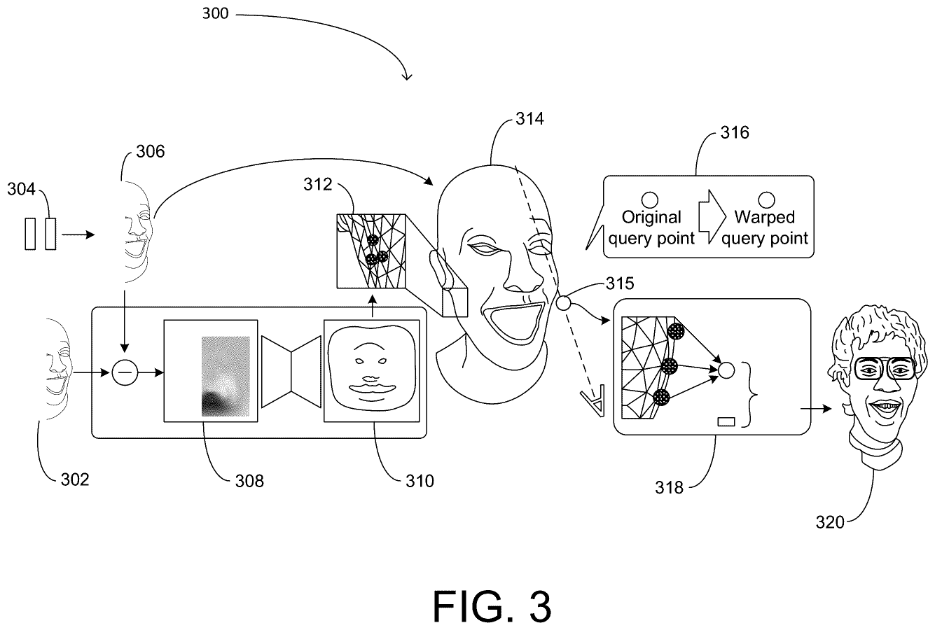

FIG. 3 shows a pipeline 300 for generating an avatar with a facial expression. A facial expression is an example of a gesture. The pipeline 300 generates the modified avatar 118 based on images captured by the camera 106 by displacing vertices included in the model representing the avatar 114 based on the second sequence of images 116. The pipeline 300 can be performed by and/or included in a computing system, such as the computing system that generated the avatar 114 based on the first sequence of images 112 and/or generated the modified avatar 118 based on the second sequence of images 116 as described above with respect to FIG. 1.

The pipeline 300 can begin with an avatar 302. The avatar 302 can have a neutral and/or blank facial expression. The computing system may have generated the avatar 302 based on a video and/or sequence of images, such as the first sequence of images 112.

The computing system can receive another sequence of images 304, which can be similar to the second sequence of images 116. The sequence of images 304 can include images of a user such as the first user 102. The sequence of images 304 can include one or more facial expressions of the first user 102. Each image and/or frame within the sequence of images 304 can include a slightly different facial expression as the face of the first user 102 transitions between facial expressions. The computing system can determine and/or generate a facial expression 306 based on the sequence of images 304. The facial expression 306 can be an example of a gesture.

The computing system can combine the facial expression 306 with the avatar 302 to generate and/or determine a vertex displacement 308. The computing system determines vertex displacements within the model of the avatar based on the sequence of images 304. In some examples, the computing system determines vertex displacements by determining mesh vertex locations of a model of an expression avatar based on one or more images in the sequence of images 304. The sequence of images 304 includes the current facial expression 306 of the user. The computing system determines a difference between the mesh vertex locations of the model of the expression avatar and mesh vertex locations of the model of the avatar 302 based on one or more images in the sequence of images 304 (based on which the facial expression 306 is determined) and mesh vertex locations of the model of the avatar 302. The difference between the mesh vertex locations of the model of the expression avatar (which can be considered expression vertex locations) based on one or more images in the sequence of images 304 and mesh vertex locations of the model of the avatar 302 is calculated as a vertex displacement 308. The computing system modifies the model of the avatar based on the vertex displacement 308 that was calculated based on the facial expression 306. The vertex displacement 308 can include a change of location, and/or change of one or more features, of a vertex included in the 3DMM of the avatar 302. The vertex displacement 308 can include one or multiple vertex displacements. The computing system modifies the vertex locations of the model for the avatar 302 based on the vertex displacement 308, such as by adding or subtracting the vertex displacement 308 to or from the vertex locations of the model for the avatar 302. Based on applying the vertex displacement 308 to the model of the avatar 302, the computing system can generate a mesh model 310 of the user 102. The mesh model 310 can include a mesh layer representing the avatar 302 with displaced vertices. The mesh model 310 can be a collection of vertices, edges between vertices, and faces formed by the edges. The collection of vertices, edges between vertices, and faces formed by the edges can form (e.g., can collectively define) a surface of the face and/or head of the avatar 114 and/or modified avatar 118.

After generating the mesh model 310, the computing system can attach features to the vertices (312). The attaching of features to the vertices (312) can include changing values of features at the vertices in the mesh model 310. The features are attached to the vertices by associating feature vectors which have vector values (such as density and color) with the vertices. The computing system predicts vertex-attached features within the mesh model 310 with vertex displacement 308 by computing vertex displacements from the 3DMM expression and pose. The computing system computes vertex displacements (which can also be considered displacement of a vertex) based on differences between locations of features and/or portions of the face or head of the user 102 (such as locations of portions of the cheeks, mouth, lips, or eyes) in the second sequence of images 116 (from which the gesture and/or facial expression was determined) and the locations of the features and/or portions of the face or head of the first user 102 in the first sequence of images 112 (from which the neutral and/or blank expression of the avatar 302 was determined). The computing system can then process the displacements of the vertices, such as in UV space, with convolutional neural networks and sample features associated with the vertices back to mesh vertices. The sampling of the features (such as color or density) associated with vertices can include determining average (mean, median, or mode) values of nearest-neighbor vertices and assigning the average values to the nearby mesh vertices.

In some examples, the attachment of features to vertices (312), avatar representation 314, warp field 316, and camera view perspective 318 generate a 3DMM-anchored neural radiance field (NeRF). A warp field includes warped points that are used as query points to decode color and/or density of vertices. A warp field is applied during training a neural network to generate and modify avatars. The computing system can decode the 3DMM-anchored NeRF from local features attached to the 3DMM vertices. The computing system can compute the output image 320 by performing volumetric rendering. Performing the volumetric rendering includes creating the two-dimensional representation of the avatar with a facial expression based on multiple images (the sequence of images 304) of the face and/or head of the first user 102.

The attachment of features to the vertices (312) can generate an avatar representation 314. The avatar representation 314 can include the facial expression of the first user 102 captured in the sequence of images 304. The avatar representation 314 can have similar features as the modified avatar 118.

For a given query point 315 within the avatar representation 314, the computing system can generate a warp field 316. The computing system can generate the warp field 316 for each frame within the sequence of images 304. The generation of the warp field 316 can include beginning with an original query point and generating a warped query point based on the original query point. The computing system can generate the warped query point based on the vertex displacement 308 and the original query point.

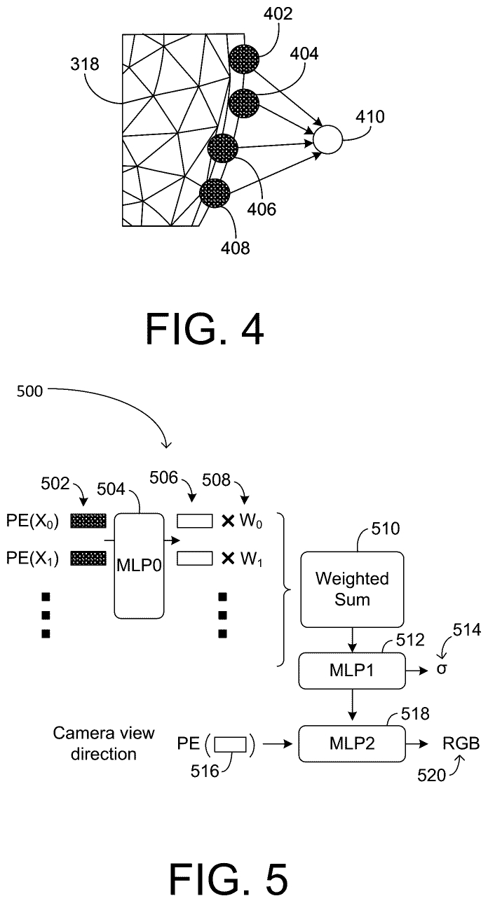

Based on the given query point 315, the computing system can generate a camera view perspective 318. The camera view perspective 318 can include an image from the perspective of the camera 106. The camera view perspective 318 is described further below with respect to FIG. 4. Based on the camera view perspective 318, the computing system can generate an image 320 of the first user 102. The image 320 is a photorealistic representation of the first user 102 based on the avatar 302.

FIG. 4 shows vertices 402, 404, 406, 408 included in a model of an avatar. The vertices 402, 404, 406, 406, 408 are vertices of triangles included in the mesh representation of the avatar. A query generates a value based on values of vertices near the point and/or location of the query. The vertices 402, 404, 406, 408 are determined when generating the camera view perspective 318. The vertices 402, 404, 406, 408 can be included in a 3DMM of the avatar. In some examples, the computing system attaches a feature vector to each vertex 402, 404, 406, 408. The feature vectors can encode local radiance fields that can be decoded with Multi-Layer Perceptrons (MLPs). The MLPs can be continuous functions by which the radiance fields model the appearance and geometry of the three-dimensional face and/or head to generate the avatar.

The computing system can determine the vertices 402, 404, 406, 408 with respect to a query point 410. The query point 410 can represent a location in three-dimensional space and/or UV space on a surface of the avatar. Given the query point 410, the computing system can find k-Nearest-Neighbor (k-NN) vertices (an example of multiple nearest-neighbor vertices of a three dimensional point) within the model of the avatar. While the value of k is four (4) in FIG. 4, k can be any integer value. The computing system can decode the vertices 402, 404, 406, 408 into a density and color with respect to a direction of the camera 106. Decoding the vertices can include, for example, determining a mean value for the density of the vertices 402, 404, 406, 408 and a mean value for the color of the vertices 402, 404, 406, 408, determining a median value for the density of the vertices 402, 404, 406, 408 and a median value for the color of the vertices 402, 404, 406, 408, determining a mode for the density of the vertices 402, 404, 406, 408 and a mode for the color of the vertices 402, 404, 406, 408, or any combination thereof. In some examples, the computing system decodes the vertices 402, 404, 406, 408 with respect to a direction from which the camera 106 receives input. In some examples, the computing system decodes the vertices 402, 404, 406, 408 via Multi-Layer Perceptions (MLPs) interleaved with inverse-distance based weighted sums. A radiance field for a given three-dimensional point in the model is generated by interpolating features of the K-nearest neighbor vertices 402, 404, 406, 408 on the model, such as the 3DMM mesh. The features are passed through an MLP to infer density and color of the three-dimensional point of an avatar 302, facial expression 306, modified avatar, expression avatar, and/or image 320. In some examples, local features and a local MLP are trained jointly by supervising the radiance field through volumetric rendering on a training sequence. The computing system can thereby determine a feature, such as a color, or a three-dimensional point of an avatar based on colors (such as averages of colors) of multiple nearest-neighbor vertices of the three-dimensional point.

To decode features {zⁱ) into a radiance field for a frame i (where i denotes a frame index of an image captured by a camera and j denotes an index of a vertex), given a three-dimensional query point 410 (denoted q), the computing system can begin by finding the k-Nearest-Neighbor (k-NN) vertices 402, 404, 406, 408 from a 3DMM mesh {vᵢ^{j}}j∈Nₖ^{q} with attached features {z^{j}}j∈Nₖ^{q}. The computing system can apply two MLPs F₀ and F₁ with inverse-distance based weighted sums to decode local color and density. The computing system can apply the equations:

\hat{z}ᵢ^{j}=F₀(vᵢ^{j}−q,zⁱ)

\hat{z}ᵢ=Σⱼω^{j}\hat{z}ᵢ^{j}

cᵢ(q,dᵢ),σᵢ(q)=F₁(\hat{z}ᵢ,dᵢ),

where ω^{j}=d^{j}/(Σₖd^{k}), d^{j}=1/(∥vᵢ^{j}−q∥) with j∈Nₖ^{q}, and dᵢ denotes a direction in which the camera 106 is capturing images. The computing system can render the output image (such as the first avatar 102A) given a camera ray r(T)=o+td:

Ci(r)=∫ₜₙ^{tf}T(t)σᵢ(r(t))cᵢ(r(t),d)dt,

where T(t)=exp(−∫ₜₙ^{t}σᵢ(r(s))ds).

The computing system can learn error-correcting warping fields during training to reduce misalignments caused by per-frame contents that were not captured by 3DMM (such as 3DMM fitting errors). The computing system can, for example, input an original query point and a per-frame latent code eᵢ (eᵢ can be randomly initialized and optimized during training) into error correction MLPs F_{ε} to predict a rigid transformation, and apply the MLP F_{ε} to the query point. The transformation can be denoted q′=Tᵢ(q)=F_{ε}(q,eᵢ). The computing system can apply a warped query point q′ to decode color and density.

In some examples, an image-to-image translation U-Net transforms 3DMM deformation in UV space to local features. The computing system can attach UV-space features to corresponding vertices of a 3DMM mesh geometry. Attaching features to the vertices enables the model, such as the 3DMM model, to retain high-frequency expression-dependent details. The convolutional neural network runs on per-vertex displacement in UV space and learns local expression-dependent features.

FIG. 5 shows a pipeline 500 for generation of an image based on vertices and features included in the model of the avatar. The pipeline 500 applies functions to the positions of the vertices to generate modified avatars. The pipeline begins with positional encoding values 502 (denoted x₀, x₁, etc.) that are based on the vertices 402, 404, 406, 408 and associated query points 410. The positional encoding values 502 can be based on a difference between the vertices 402, 404, 406, 408 and associated query points 410, such as xⱼ=vⱼ−q. The computing system can apply a first Multi-Layer Perceptron (MLP0) 504 to the positional encoding values to generate radiance fields 506. The computing system can generate a weighted sum 510 by multiplying the radiance fields 506 by weights 508 (weights can be denoted w₀, w₁, etc.). The weights 508 can be based on the positional encoding values 502, such as reciprocals of the absolute values of the positional encoding values 502 (e.g. wᵢ=1/∥xⱼ∥). The computing system can apply a first Multi-Layer Perceptron (MLP1) 512 to the weighted sum 510 to generate and/or decode a density value 514, and can apply the first Multi-Layer Perceptron (MLP1) 512 and a second Multi-Layer Perceptron (MLP2) 518), as well as a direction 516 from which the camera 106 captures images, to generate and/or decode a local color 520.

In some examples, the computing system processes a 3DMM expression and pose with a convolutional neural network in a texture atlas space (UV space) to provide local spatial context. In some examples, the computing system trains a decoder that includes transposed convolutional blocks to predict a feature map in UV space directly from one-dimensional codes of 3DMM expression and pose. In some examples, the computing system applies three-dimensional deformation of the 3DMM model in UV space as an input for feature prediction. The computing system can compute vertex displacements using 3DMM expression and pose, and rasterize the vertex displacements into UV space, processing the UV space with a U-Net. The computing system can sample the output UV feature map back to mesh vertices that serve as dynamic vertex features, and generate the modified avatar 118 based on the dynamic vertex features.

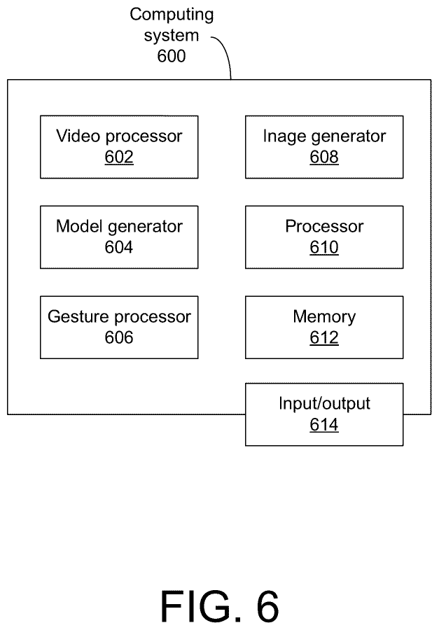

FIG. 6 shows a computing system 600 for generation and modification of an avatar. The computing system 600 can perform functions, methods, and/or techniques described above, such as generating the avatar 114, generating the modified avatar 118, generating the avatars 202 to 214 and 252 to 260, executing the pipeline 300, determining the vertices 402, 404, 406, 408 with respect to the query point 410, and/or implementing the pipeline 500. The computing system 600 can include a local computing system that includes the display 104 and camera 106, a server that is remote from the local computing system, or a distributed system that distributes tasks between the local computing system and the server, as non-limiting examples.

The computing system 600 can include a video processor 602. The video processor 602 can process videos, which can be considered sequences of images, such as the first sequence of images 112, the second sequence of images 116, the first video 200, and/or the second video 250. The images can include a portion of a user 102, 152, such as a head of the user 102, 152 or face of the user 102, 152. In some examples, the video processor 602 removes backgrounds from the images. The backgrounds can be considered portions of the images other than the portion of the user (such as the head of the user) based on which the avatar is generated and/or modified. The video processor 602 can process images and/or videos captured by a camera, such as the camera 106 and/or camera 156. The camera that captured the images can be a monocular camera such as a color camera. The camera that captures the images and/or videos processed by the video processor 602 can be included in and/or a component of the computing system 600 (such as a component of the video processor 602), or can be in communication with the computing system 600.

The computing system 600 can include a model generator 604. The model generator 604 can generate a model based on the images and/or video(s) captured by the video processor 602. The computing system 600 can generate an avatar based on the model generated by the model generator 604. In some examples, the model generated by the model generator 604 is a parametric face model. In some examples, the model generated by the model generator 604 includes a feature vector associated with a vertex. The feature vector can include values, such as a density value and one or more color values (such as a value for the color red, a value for the color green, and a value for the color blue). The model can include a three-dimensional morphable model (3DMM). The vertex can be included in the 3DMM. In some examples, the model generated by the model generator 604 includes multiple vertices and a feature vector associated with each vertex of the multiple vertices. In some examples, the model generator 604 applies a convolutional neural network to the images and/or video(s) captured by the video processor 602 to generate the one or multiple feature vectors associated with the one or multiple vertices. The convolutional neural network incorporates spatial context in UV space and produces representative local features, such as features of a face of the first user 102. The convolutional neural network predicts expression-dependent spatially local features on a surface of the model, such as the 3DMM mesh, based on which the avatar is generated.

The computing system 600 can include a gesture processor 606. The gesture processor 606 can determine and/or generate gestures based on images and/or videos processed by the video processor 602. Facial expressions are examples of gestures that the gesture processor 606 can determine and/or generate. The gesture processor 606 can modify an avatar to generate the avatar 114 based on images and/or videos processed by the video processor 602.

In some examples, the gesture processor 606 determines and/or generates gestures by displacing a vertex included in the model generated by the model generator 604. In some examples, the gesture processor 606 determines and/or generates gestures by displacing multiple vertices included in the model generated by the model generator 604.

The computing system 600 can include an image generator 608. The image generator 608 can generate images based on the model generated by the model generator 604 and/or modified by the gesture processor 606. The image generator 608 can generate graphical output, such as facial images and/or head images with expressions that modify the avatar. In some examples, the image generator 608 generates the graphical output by rasterizing displacement of one or multiple vertices (which were displaced by the gesture processor 606) into UV space. Rasterization includes determining pixels, and colors of the pixels, of an image to represent objects (such as portions of a face and/or shapes of the portions of the face) based on locations and features of the vertices.

The computing system 600 can include at least one processor 610. The at least one processor 610 can execute instructions, such as instructions stored in at least one memory device 612, to cause the computing system 600 to perform any combination of methods, functions, and/or techniques described herein.

The computing system 600 can include at least one memory device 612. The at least one memory device 612 can include a non-transitory computer-readable storage medium. The at least one memory device 612 can store data and instructions thereon that, when executed by at least one processor, such as the processor 610, are configured to cause the computing system 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 600 can be configured to perform, alone, or in combination with the computing system 600, any combination of methods, functions, and/or techniques described herein.

The computing system 600 may include at least one input/output node 614. The at least one input/output node 614 may receive and/or send data, such as from and/or to, a server or other computing device, and/or may receive input and provide output from and to a user. The input and output functions may be combined into a single node, or may be divided into separate input and output nodes. The input/output node 614 can include a microphone, a camera (such as the camera 106 or camera 156), a display, a speaker, a microphone, one or more buttons (such as a keyboard), a human interface device such as a mouse or trackpad, and/or one or more wired or wireless interfaces for communicating with other computing devices such as a server and/or the computing devices that captured images of the user 102, 152.

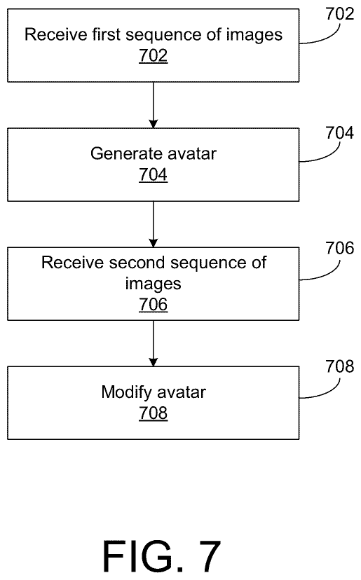

FIG. 7 shows a flowchart for generation and modification of an avatar. The method includes receiving a first sequence of images (702). Receiving a first sequence of images (702) can include receiving a first sequence of images of a portion of a user, the first sequence of images being monocular images. The method includes generating an avatar (704). Generating an avatar (704) can include generating an avatar based on the first sequence of images, the avatar being based on a model including a feature vector associated with a vertex. The method includes receiving a second sequence of images (706). Receiving a second sequence of images (706) can include receiving a second sequence of images of the portion of the user. The method includes modifying the avatar (708). Modifying the avatar (706) can include, based on the second sequence of images, modifying the avatar with a displacement of the vertex to represent a gesture of the avatar.

In some examples, the modifying the avatar with the displacement of the vertex includes determining a vertex location of a model of an expression avatar based the second sequence of images, determining displacement of the vertex based on the vertex location of the model of the expression avatar and a location of the vertex, and modifying a location of the vertex based on the displacement of the vertex.

In some examples, the method further includes determining a color of a three-dimensional point of the avatar based on colors of multiple nearest-neighbor vertices of the three-dimensional point, the multiple nearest-neighbor vertices of the three-dimensional point including the vertex.

In some examples, the method further includes determining the displacement of the vertex based on a difference between a feature of the portion of the user in the first sequence of images and a feature of the portion of the user in the second sequence of images.

In some examples, the model includes a three-dimensional morphable model configured to be translated into a two-dimensional representation for presentation on a computer display, and the vertex is a mesh vertex included in the three-dimensional morphable model.

In some examples, the method further includes determining an expression vertex location within an expression avatar based on the second sequence of images, and determining the displacement of the vertex based on the expression vertex location and a location of the vertex.

In some examples, the method further includes generating the avatar includes applying a convolutional neural network to the first sequence of images to generate the feature vector associated with the vertex.

In some examples, the method further includes the model includes a triangle mesh and the vertex is included in a triangle in the triangle mesh.

In some examples, the method further includes the gesture of the avatar includes a facial expression.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving a first sequence of images of a portion of a user, the first sequence of images being monocular images;
generating an avatar based on the first sequence of images, the avatar being based on a model including a feature vector associated with a vertex;
receiving a second sequence of images of the portion of the user; and
based on the second sequence of images, modifying the avatar with a displacement of the vertex to represent a gesture of the avatar.

2. The method of claim 1, wherein the modifying the avatar with the displacement of the vertex includes:
determining a vertex location of a model of an expression avatar based the second sequence of images;
determining displacement of the vertex based on the vertex location of the model of the expression avatar and a location of the vertex; and
modifying a location of the vertex based on the displacement of the vertex.

3. The method of claim 1, further comprising determining a color of a three-dimensional point of the avatar based on colors of multiple nearest-neighbor vertices of the three-dimensional point, the multiple nearest-neighbor vertices of the three-dimensional point including the vertex.

4. The method of claim 1, further comprising determining the displacement of the vertex based on a difference between a feature of the portion of the user in the first sequence of images and a feature of the portion of the user in the second sequence of images.

5. The method of claim 1, wherein:
the model includes a three-dimensional morphable model configured to be translated into a two-dimensional representation for presentation on a computer display; and
the vertex is a mesh vertex included in the three-dimensional morphable model.

6. The method of claim 1, further comprising:
determining an expression vertex location within an expression avatar based on the second sequence of images; and
determining the displacement of the vertex based on the expression vertex location and a location of the vertex.

7. The method of claim 1, wherein generating the avatar includes applying a convolutional neural network to the first sequence of images to generate the feature vector associated with the vertex.

8. The method of claim 1, wherein the model includes a triangle mesh and the vertex is included in a triangle in the triangle mesh.

9. The method of claim 1, wherein the gesture of the avatar includes a facial expression.

10. A non-transitory computer-readable storage medium comprising instructions stored thereon that, when executed by at least one processor, are configured to cause a computing system to:
receive a first sequence of images of a portion of a user, the first sequence of images being monocular images;
generate an avatar based on the first sequence of images, the avatar being based on a model including a feature vector associated with a vertex;
receive a second sequence of images of the portion of the user; and
based on the second sequence of images, modify the avatar with a displacement of the vertex to represent a gesture of the avatar.

11. The non-transitory computer-readable storage medium of claim 10, wherein the modifying the avatar with the displacement of the vertex includes:
determining a vertex location of a model of an expression avatar based the second sequence of images;
determining displacement of the vertex based on the vertex location of the model of the expression avatar and a location of the vertex; and
modifying a location of the vertex based on the displacement of the vertex.

12. The non-transitory computer-readable storage medium of claim 10, wherein the instructions are further configured to cause the computing system to determine a color of a three-dimensional point of the avatar based on colors of multiple nearest-neighbor vertices of the three-dimensional point, the multiple nearest-neighbor vertices of the three-dimensional point including the vertex.

13. The non-transitory computer-readable storage medium of claim 10, wherein the instructions are further configured to cause the computing system to determine the displacement of the vertex based on a difference between a feature of the portion of the user in the first sequence of images and a feature of the portion of the user in the second sequence of images.

14. The non-transitory computer-readable storage medium of claim 10, wherein:
the model includes a three-dimensional morphable model configured to be translated into a two-dimensional representation for presentation on a computer display; and
the vertex is a mesh vertex included in the three-dimensional morphable model.

15. The non-transitory computer-readable storage medium of claim 10, wherein the instructions are further configured to cause the computing system to:
determine an expression vertex location within an expression avatar based on the second sequence of images; and
determining the displacement of the vertex based on the expression vertex location and a location of the vertex.

16. The non-transitory computer-readable storage medium of claim 10, wherein generating the avatar includes applying a convolutional neural network to the first sequence of images to generate the feature vector associated with the vertex.

17. A computing system comprising:
at least one processor; and
a non-transitory computer-readable storage medium comprising instructions stored thereon that, when executed by the at least one processor, are configured to cause the computing system to:
receive a first sequence of images of a portion of a user, the first sequence of images being monocular images;
generate an avatar based on the first sequence of images, the avatar being based on a model including a feature vector associated with a vertex;
receive a second sequence of images of the portion of the user; and
based on the second sequence of images, modify the avatar with a displacement of the vertex to represent a gesture of the avatar.

18. The computing system of claim 17, wherein the modifying the avatar with the displacement of the vertex includes:
determining a vertex location of a model of an expression avatar based the second sequence of images;
determining displacement of the vertex based on the vertex location of the model of the expression avatar and a location of the vertex; and
modifying a location of the vertex based on the displacement of the vertex.

19. The computing system of claim 17, wherein the instructions are further configured to cause the computing system to determine a color of a three-dimensional point of the avatar based on colors of multiple nearest-neighbor vertices of the three-dimensional point, the multiple nearest-neighbor vertices of the three-dimensional point including the vertex.

20. The computing system of claim 17, wherein the instructions are further configured to cause the computing system to determine the displacement of the vertex based on a difference between a feature of the portion of the user in the first sequence of images and a feature of the portion of the user in the second sequence of images.
